(19) United States
(12) Patent Application Publication
(10) Pub. No.: US 2021/0212509 A1
(43) Pub. Date: Jul. 15, 2021

(54) BUTANE GAS FOLDABLE GRILL

(71) Applicant: Armando Medina Cantu, Monterrey (MX)

(72) Inventor: Armando Medina Cantu, Monterrey (MX)

(21) Appl. No.: 16/741,173

(22) Filed: Jan. 13, 2020

(51) Int. Cl. A47J 37/07; F24C 3/14; F24C 15/08

(52) U.S. Cl. CPC A47J 37/0763; A47J 2037/0777; F24C 15/086; F24C 3/14

(57) ABSTRACT

Currently, outdoor activities are on the rise. The most common activities are those done to get away from the hustle and bustle of the city and/or spend long periods of time together, which therefore imply cooking outside the home or taking food preparation out of the conventional kitchen. Accordingly, a lightweight portable butane gas grill was created, which has the purpose of being easily and comfortably transported, and that allows a 22-inch disk to be incorporated in order to cook food without the need to light coal or firewood as is traditionally done outside a conventional kitchen.

### TECHNICAL FIELD AND BACKGROUND OF THE INVENTION

The disclosed grill consists of a metal structure that allows for easy and comfortable transport, allowing it to be folded and unfolded, and includes a disk with an external diameter of 22 inches to cook food with butane gas, without the need to light coal or firewood as is traditionally done outside a conventional kitchen. This innovative utility model that consists of only two parts and which belongs to the field of manufacturing can easily be transported in a practical, simple and comfortable manner, in addition to being capable of being installed for cooking purposes in two steps and under 1 minute.

Currently, outdoor activities are on the rise. The most common activities are those carried out by more than one person or as a group, such as hunting, fishing, camping, excursions, etc. generally activities done to get away from the hustle and bustle of the city and/or spend long periods of time together which imply cooking outside of the home or taking food preparation outside of a conventional kitchen.

In the prior art that exists in relation to this utility model there are stoves, as well as griddles, both using butane gas and electricity, which bring comfort, security, simplicity and speed to food preparation. However, it is possible to be able to cook such preparations anywhere other than a conventional kitchen or outdoors using a hearth or grills. However, these practices are considered high risk and contaminating factor and on the other hand impractical due to the difficult transportation of grills and due to the risk involved since it increases the possibility of forest fires.

On the market, there are several goods to cook outside the home, however, after observing the need to prepare food in places other than the kitchen, and catering to the trend of doing so comfortably and outdoors, as well as in a safe manner and without contaminating the environment, this metal structure was designed.

### SUMMARY

The disclosed butane gas foldable grill is different and superior to conventional grills because of the following improvements and characteristics:
1. Portable: It consists of only 2 loose elements instead of 3 or 4 that allows its transportation and easy installation, because the disk used to cook food can be carried in one hand and the structure in the other hand
2. Light and easy transportation: Since it is made of lightweight material that also allow it to have a mechanism that allows it to rotate and therefore be folded and unfolded, contrary to disassembling it into several parts since, by having several parts, its transportation is more difficult.
3. Installation speed: Since you can install it in just 2 steps so that it is ready to cook in under 1 minute.
4. Versatility: because you can place any cooking disk you have, not necessarily the one that is included, as well as a butane gas fuel tank, disposable or not, which makes it even more inexpensive and versatile in use. In addition to the above, on the bottom of its legs it has an adjustable height regulator which allows you to adjust it to a maximum difference of one inch.
5. Comfort: It only consists of only 1 element that allows it to fold and unfold easily and quickly, in addition to having adjustable height regulators on all 4 legs and consequently the height of the grill is as stable and comfortable as possible when cooking.
6. Durability: It is made of highly heat resistant materials that also protect it against the elements.
7. Safety: since it is a non-contaminating product, because in addition to immediately being put out, it is not left to the elements and therefore the risk factor that can cause a forest fires is eliminated.

### BRIEF DESCRIPTION OF THE DRAWINGS

These and other features, aspects and advantages of the present invention are better understood when the following detailed description of the invention is read with reference to the accompanying drawings, in which:

FIG. 1 is the front view of the whole open structure, showing the elements that comprise it.

FIG. 2 is a top view of the structure showing the structure in a closed position.

FIG. 3 is a bottom view of the structure showing the four height adjusters, one on each leg.

FIG. 4 is the side view of the structure showing the burner with a valve and nozzle, which enables the safe installation of a butane gas fuel tank, disposable or not.

FIG. 5 is a side view of the central body of the structure showing the components that are inside its interior; in addition to its functionality as an axis, since it raises the structure, the spring compresses in order to be able to rotate it.

FIG. 6 is a side view of the structure showing way a flat disk can be placed.

FIG. 7 is a top view of the structure showing the way any other kind of disk can be placed, as well as the existing paint colors, preferably anti-corrosive, with which the structures are finished.

FIG. 8 is a top view of the structure showing the way pressure must be exerted upon the structure with the foot in order to fold and unfold it.

FIG. 9 is a top view of the structure showing the way it rotates.

### DETAILED DESCRIPTION OF THE INVENTION

The parts and characteristic details of this utility model are described and shown in detail below:

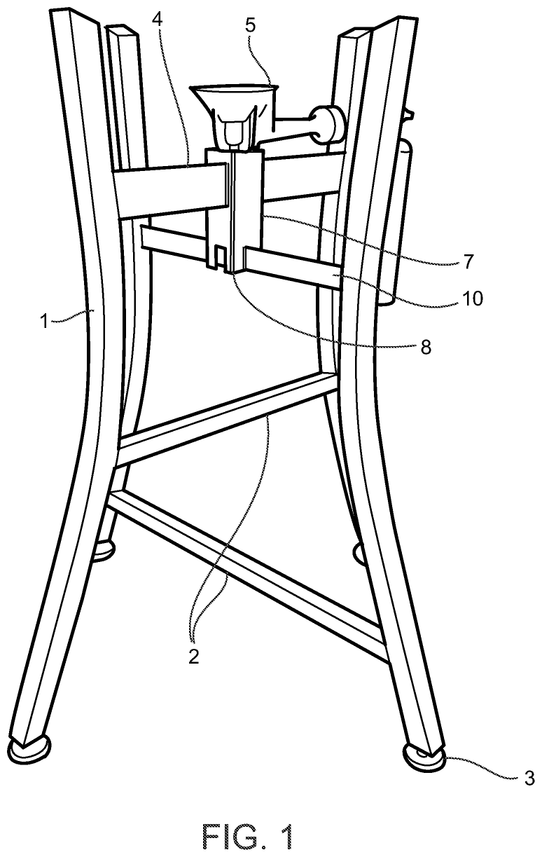

FIGS. 1-9 generally depict the butane gas foldable grill, which is disclosed further below. Lightweight metal structure preferably made from carbon steel (A36). It is made of four square hollow legs (1). Each of them with a slightly curved anatomy, resembling a parabolic curve without excessive curves and proportionately joined in pairs by two crossbars (2), as if they were two meeting parabolic curves with the purpose of supporting a disk to cook meals. The result is two connected parts, as is shown in FIG. 1.

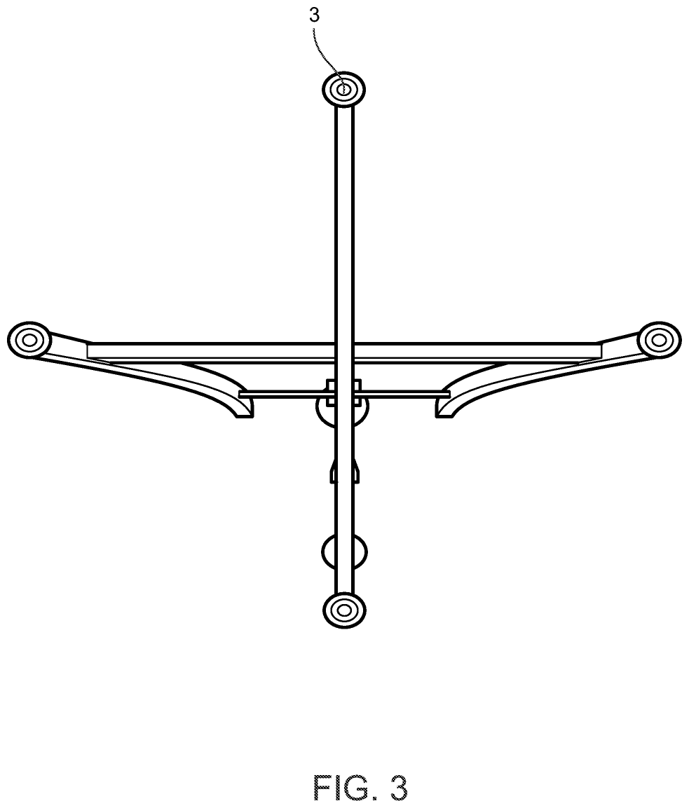

At the end of each of the legs there are adjustable height regulators (4) (on all four legs that support the structure). These height regulators raise and descend 1 inch and are independent, making the height adjustment of the structure versatile. They are turned by hand without the need for tools, as is shown in FIG. 3.

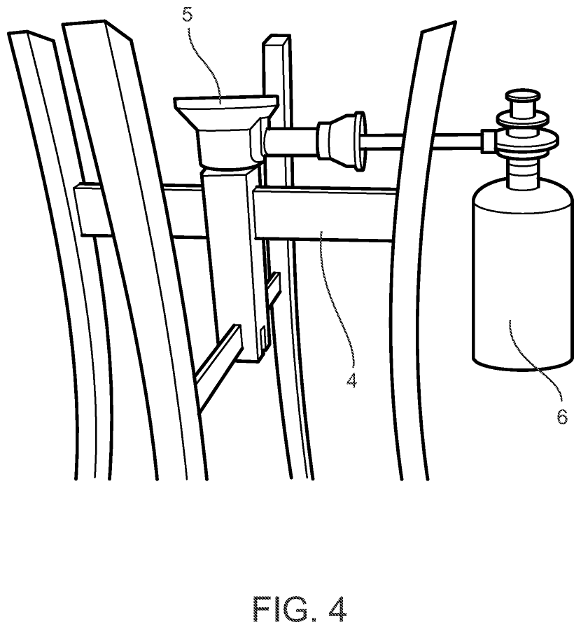

The top crossbar (4) of the metal structure contains a burner (5) with a valve and nozzle, which enables the safe installation of a butane gas fuel tank (6), preferably disposable, or no, as is shown in FIG. 4.

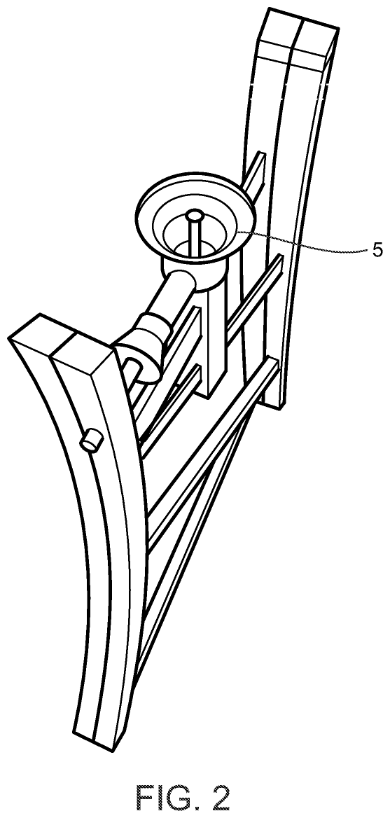

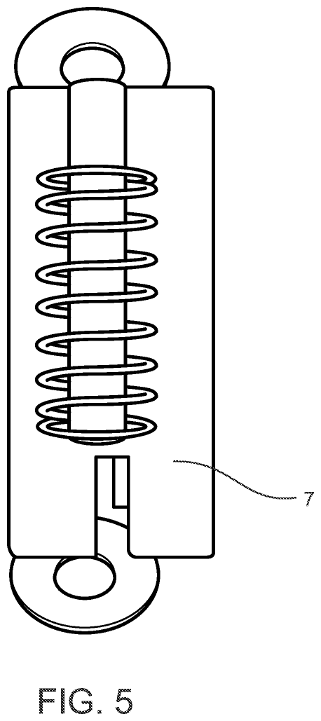

The central body (7) of such structure, serving as axis that allows it to rotate, comprises a square tube containing in its interior a metal cylinder covered by a spring and with washers placed on its ends (washers that are placed on the bottom and top of the spring and inside the cylinder). This mechanism, when pressure is exerted on it in an upwards direction, i.e. raising the structure with both hands, allows the spring to be compressed and allows it to be rotated and therefore be folded or unfolded, leaving the structure completely open (in position to place disk, FIG. 1), or completely closed (for handling and transportation, FIG. 2). The composition of this mechanism is better observed in FIG. 5. The bottom of this body also has slots (8), allowing it to fit perfectly with a third crossbar (10) of the structure, since when it is rotated, and having it in the correct position, the slots of such crossbar fit together, no longer exerting upward force, therefore the spring returns to its normal state, allowing it therefore to perfectly set the and avoiding it being involuntarily opened or closed.

The whole metal structure is finished with anti-corrosion and heat resistant paints (that can be of different colors such as red, green or black). This also allows it to be highly durable against the climate conditions that exist outdoors, as well as the normal and customary wear and tear of this article (due to the high temperatures when it is being used).

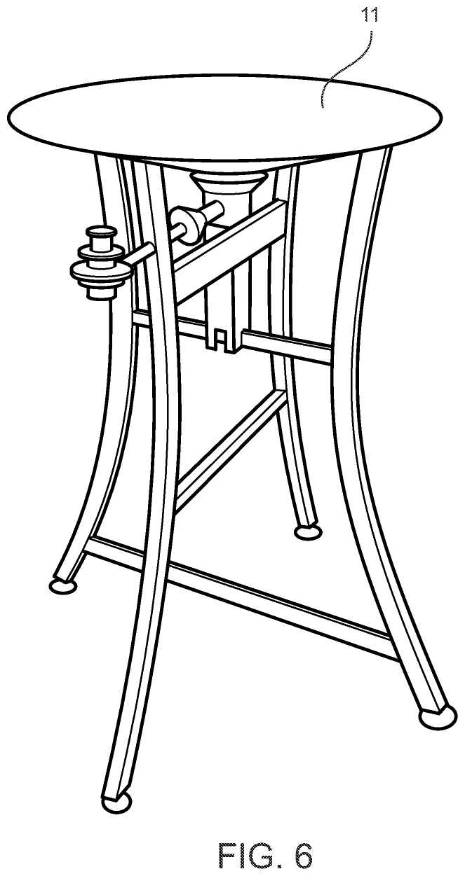

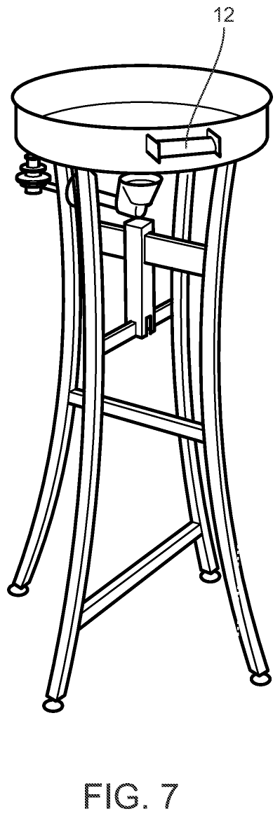

The metal structure allows a disk with an external diameter of 22 inches to be placed on its top (11) to cook food, which can be of different shapes or made from different materials such as carbon steel and/or stainless steel, as is shown in FIG. 6. This disk has four steel strips to place it on said metal structure and it also has two wooden or plastic handles (12); two on each side, as is shown in FIG. 7.

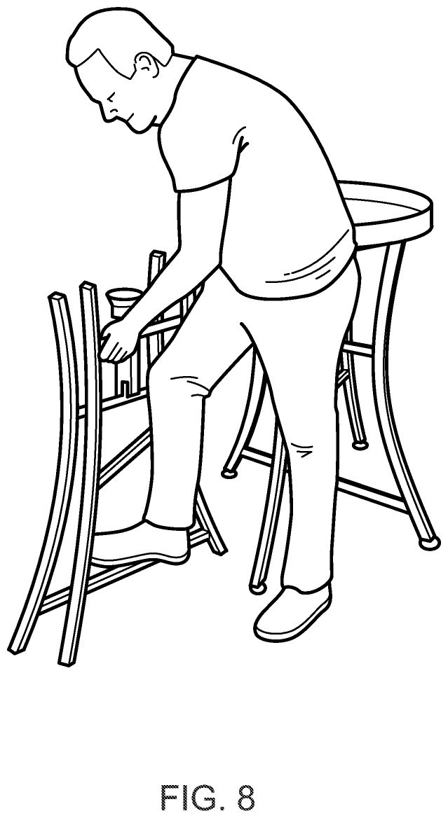

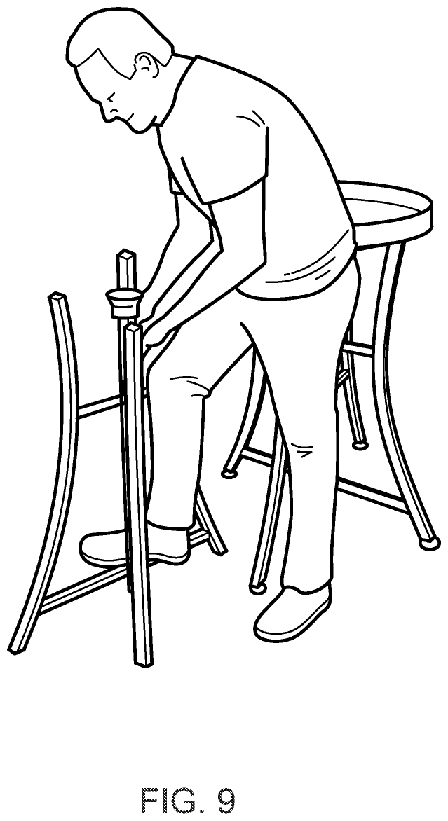

Basically, the intention is that any person qualified in the field of invention will be able to reproduce and use my invention just like I do. For said purpose we recommend you follow these instructions:
a) Place the structure on the floor, two of these legs will be available for this. You need to hold it from both ends of the top crossbar and with both hands (equally).
b) Once in the position described above, either of the feet are placed on the structure's crossbar closest to the floor, which will help exert pressure and to make a slight upward movement.
c) With the foot placed on the structure's crossbar closest to the floor, an upward movement is made on the structure with both hands simultaneously pressing with the foot in order to prevent the structure from moving and consequently the square body that is in the center can become free or released from the crossbar it is secured to, as is shown in FIG. 8.
d) Once the body is released and continuing to exercise the same upward force, the structure is rotated with both hands towards the left in order to unfold it, as is shown in FIG. 9.
e) The slots of the body are positioned so that they fit on the crossbar, no longer exerting upward force so that the spring can return to its normal state and it can be perfectly placed on the crossbar that is naturally available for such purpose. This will prevent the structure to involuntarily fold or unfold, serving as a lock that keeps it in a position to place a cooking disk, as is shown in FIG. 1.
f) Lastly the butane gas tank is installed, rotating it on the entry indicated for such purpose.
g) The disk is placed, and the fire is lit with a lighter or matches.
h) The procedure to fold the structure (keep it closed) is exactly the same, because you only need to exert an upward pressure movement allowing the rotation to be made and fit the slots on the crossbar so that they can function as a lock, preventing the structure from involuntarily folding or unfolding. FIG. 2.

What is claimed is:

1. A butane gas foldable grill comprising a central body on a metal structure that serves as an axis of rotation of the central body to fold and unfold the butane gas foldable grill.

2. The butane gas foldable grill according to claim 1, wherein the central body of the metal structure has a mechanism that functions as an axis comprised of a square tube containing in its interior a spring biased metal cylinder configure to raise and lower the central body when pressure is exerted thereon and allows a spring to be compressed so that the central body can be rotated.

3. The butane gas foldable grill according to claim 1, wherein the central body of the metal structure that has a mechanism that functions as an axis comprised of a square tube that, in addition to the internal mechanism, has slots on a bottom part, that allows the central body to fit onto a second crossbar of the metal structure, and upon rotating the central body into a position in which the slots fit on the second crossbar and the spring returns to its normal state, thereby allowing the structure to lock and keeping it from becoming involuntarily opened or closed.

4. The butane gas foldable grill according to claim 1, wherein the central body of the metal structure has a mechanism that functions as an axis comprised of a square tube that, in addition to the internal mechanism, has slots on a bottom part and a burner, valve and nozzle on the top part that aid to install a butane gas fuel tank on the mechanism to cook food.

5. The butane gas foldable grill according to claim 1, wherein the metal structure comprises a carbon steel, and has a central body with a mechanism that functions as an axis and that allows the central body to rotate in order to fold or unfold, the metal structure comprised of four square hollow legs with each leg being slightly curved and the legs being joined in pairs by two crossbars which are linked between themselves to support a disk with predetermined external diameter to cook meals thereon.

6. The butane gas foldable grill according to claim 1, wherein the metal structure comprises a carbon steel, and having legs in which at an end of each of the leg adjustable height regulators are affixed thereon to independently raise and lower height by a predetermined amount.

7. The butane gas foldable grill according to claim 1, wherein the light metal structure comprises a carbon steel having anti-corrosion and heat resistant paints applied thereon and that durable against outdoor climate conditions, as well as the normal and customary wear and tear.
